(19) United States
(12) Patent Application Publication
(10) Pub. No.: US 2026/0093987 A1
(43) Pub. Date: Apr. 2, 2026

(54) COMPUTER SYSTEM AND METHOD FOR QUANTIZING ARTIFICIAL NEURAL NETWORK MODEL

(71) Applicant: NOTA, INC., Daejeon (KR)

(72) Inventors: Tairen Piao, Daejeon (KR); Shinkook Choi, Daejeon (KR)

(73) Assignee: NOTA, INC., Daejeon (KR)

(21) Appl. No.: 18/945,122

(22) Filed: Nov. 12, 2024

(30) Foreign Application Priority Data
Sep. 30, 2024 (KR) 10-2024-0133138

(51) Int. Cl. G06N 3/082

(52) U.S. Cl. CPC G06N 3/082

(57) ABSTRACT

Provided is a quantization method of an artificial neural network model including a plurality of layers. The quantization method includes identifying an outlier from among activation elements output from a first layer among the layers of the artificial neural network model, determining and regularizing a weight to be regularized among weights applied to the first layer based on relevance with the identified outlier, and quantizing the artificial neural network model after the quantization.

### CROSS-REFERENCE TO RELATED APPLICATION(S)

This application claims the priority benefit of Korean Patent Application No. 10-2024-0133138, filed on Sep. 30, 2024, in the Korean Intellectual Property Office, the disclosure of which is incorporated herein by reference.

### BACKGROUND

### 1. Field

The present disclosure relates to a computer system and a method for quantizing an artificial neural network model that includes a plurality of layers and, more particularly, to a computer system and a method for determining and regularizing a weight subject to regularization among weights applied to a layer based on relevance with an outlier of an activation element output from the layer and quantizing an artificial neural network model.

### 2. Description of Related Art

An artificial neural network (ANN) includes a plurality of layers to generate an inference result from input. For example, a deep neural network (DNN) includes an input layer and an output layer and also includes a plurality of hidden layers therebetween.

The artificial neural network model is quantized to maximize computational and memory efficiency while maintaining accuracy. Quantization is to express a weight element and/or activation element, which is expressed as a floating point in the artificial neural network model, as a fixed point (i.e., expression with a smaller number of bits). Through this, by decreasing accuracy of the weight element and/or activation element, a size of the artificial neural network model may be reduced and throughput thereof may be improved. This quantization is required to implement or install the artificial neural network model in a system with limited resources, such as a mobile device or an edge computing device.

The aforementioned information is simply to help understanding and may include content that does not form a portion of the art and may not include what the art may present to one skilled in the art.

### SUMMARY

Example embodiments may provide a method that identifies an outlier from among activation elements output from a first layer among layers of an artificial neural network model, determines and regularizes a weight to be regularized among weights applied to the first layer based on relevance with the identified outlier, and quantizes the artificial neural network model after regularization.

Example embodiments may provide a method that may reduce quantization errors of an artificial neural network model by performing quantization after regularizing a weight corresponding to a main contributing factor among weights of a layer used to calculate an outlier of an activation element output from each input layer of the artificial neural network model.

According to an aspect, there is provided a quantization method of an artificial neural network model including a plurality of layers, performed by a computer system, the quantization method including identifying at least one first outlier from among first activation elements output from a first layer among the layers; identifying second weight elements associated with the first outlier from among first weight elements applied in the first layer; regularizing a second weight element determined based on relevance with the first outlier, among the identified second weight elements; and performing quantization for at least one of third weight elements applied in the first layer after the regularization or activation elements output from the first layer.

The quantization method may further include identifying second activation elements associated with the first outlier from among input activation elements that are input to the first layer, the first outlier may be calculated by operation between the second activation elements and the second weight elements, and the regularizing of the second weight element may include determining a second weight element corresponding to a main contributing factor in calculating the first outlier among the second weight elements as the second weight element subject to regularization.

Each of the first activation elements may be an element included in a first activation matrix, each of the input activation elements may be an element included in an input activation matrix, and each of the first weight elements may be an element included in a first weight matrix.

The identifying of the second weight elements may include identifying a column of the first weight matrix used to calculate an element corresponding to the first outlier of the first activation matrix, the identifying of the second activation elements may include identifying a row of the input activation matrix used to calculate the element corresponding to the first outlier of the first activation matrix, and the second weight element corresponding to the main contributing factor may be an element of the column of the first weight matrix corresponding to a largest value among element-wise products of the row of the input activation matrix and the column of the first weight matrix.

The relevance with the first outlier may be determined in consideration of second activation elements calculated with the second weight elements among input activation elements that are input to the first layer.

The regularizing of the determined second weight element may include pruning the determined second weight element.

The regularizing may be performed during quantization calibration on the artificial neural network model.

The first activation elements may be acquired by averaging the activation elements output from the first layer for each of sample inputs used for the quantization calibration.

The quantization method may further include identifying at least one outlier from among activation elements output from a second layer that follows the first layer among the layers; identifying weight elements associated with the identified outlier from among weight elements applied in the second layer; determining a weight element having the highest relevance with the identified outlier among the identified weight elements; and regularizing the weight element having the highest relevance with the outlier.

The first layer may be an input layer that is the first layer of the artificial neural network model the artificial neural network model.

Operations including the identifying of the first outlier, the identifying of the second weight elements, and the regularizing may be sequentially performed for each layer, starting from an input layer that is a first layer of the artificial neural network model among the layers, and may be performed until the artificial neural network model satisfies a preset maximum pruning rate.

The maximum pruning rate may be determined by setting an initial pruning rate; comparing an inference result by a model in which the artificial neural network model is pruned while increasing the initial pruning rate and an inference result by an initial model that is the artificial neural network model; and determining the maximum pruning rate as a value that increases the initial pruning rate, based on a change in the comparison result.

The identifying of the first outlier may include identifying the first outlier from among the first activation elements based on median absolute deviation (MAD) and a predetermined rate or number of the first activation elements.

The predetermined rate or number may be determined based on the total number of weight elements of the artificial neural network model.

According to another aspect, there is provided a computer system to perform quantization of an artificial neural network model including a plurality of layers, the computer system including at least one processor configured to execute computer-readable instructions in the computer system, wherein the at least one processor is configured to identify at least one first outlier from among first activation elements output from a first layer among the layers, to identify second weight elements associated with the first outlier from among first weight elements applied in the first layer, to regularize a second weight element determined based on relevance with the first outlier, among the identified second weight elements, and to perform quantization for at least one of third weight elements applied in the first layer after the regularization or activation elements output from the first layer.

By determining and regularizing a weight (e.g., corresponding to a main contributing factor) having high relevance with an outlier as subject to regularization among weights of a layer used to calculate the outlier of an activation element output from each input layer of an artificial neural network model and then quantizing the artificial neural network model, it is possible to effectively reduce quantization errors in quantization of the model of which training is completed (post-training quantization).

### BRIEF DESCRIPTION OF THE DRAWINGS

FIG. 1 illustrates a method of regularizing a weight based on relevance with an outlier of activation elements output from a layer of an artificial neural network model and quantizing the artificial neural network model according to an example embodiment;

FIG. 2 is a diagram illustrating a computer system to perform a quantization method of an artificial neural network model according to an example embodiment;

FIG. 3 is a flowchart illustrating a quantization method of an artificial neural network model according to an example embodiment;

FIG. 4 is a flowchart illustrating a method of regularizing a weight applied to each of a plurality of layers of an artificial neural network model and quantizing the artificial neural network model according to an example;

FIG. 5 is a flowchart illustrating a method of pruning an artificial neural network model according to a set pruning rate in regularizing the weight of the artificial neural network model according to an example;

FIG. 6 illustrates a method of identifying an outlier from among activation elements output from a layer of an artificial neural network model and performing quantization of the artificial neural network model according to an example; and

FIGS. 7 and 8 illustrate a method of identifying an outlier from among activation elements output from a first layer of an artificial neural network model, and identifying and regularizing a weight corresponding to a main contributing factor from among weights used to calculate the outlier according to an example.

### DETAILED DESCRIPTION

Hereinafter, example embodiments will be described in detail with reference to the accompanying drawings.

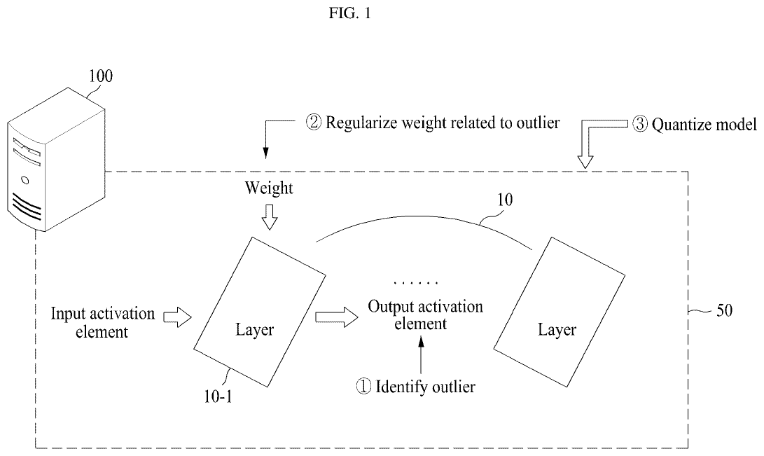

FIG. 1 illustrates a method of regularizing a weight based on relevance with an outlier of activation elements output from a layer of an artificial neural network model and quantizing the artificial neural network model according to an example embodiment.

A method of quantizing an artificial neural network model 50 (hereinafter, also referred to as model 50) in which a computer system 100 is configured by including a plurality of layers 10 is described with reference to FIG. 1.

The model 50 may include the plurality of layers 10 to generate an inference result corresponding to an output from an input. The model 50 may be, for example, a deep neural network (DNN) model, and this model 50 includes an input layer (e.g., first layer) and an output layer (e.g., last layer) and a plurality of hidden layers (e.g., intermediate layers) therebetween, as the plurality of layers 10.

The model 50 may be quantized to maximize computational and memory efficiency while maintaining accuracy. Quantization is to express a weight element and/or activation element, which is expressed as a floating point in the model 50, as a fixed point (i.e., expression with a smaller number of bits). By performing this quantization for the model 50, precision of the weight element and/or activation element applied to the layers 10 of the model 50 may decrease and accordingly, a size of the model 50 may be reduced and an inference speed of the model 50 may be accelerated. Quantization for the model 50 may be required to implement or install the model 50 in a system with limited resources, such as a mobile device or an edge computing device.

In an illustrated example, a first layer 10-1 may be one of the plurality of layers 10. For example, the first layer 10-1 may be an input layer among the plurality of layers 10.

Each layer may be a basic unit that constitutes the artificial neural network 50 and each layer may include a plurality of nodes or neurons.

A weight element may be applied to each layer. The weight element may be a parameter indicating how important an input to a layer (e.g., input activation element) is when it is delivered to each neuron, and may adjust relationship between an input (e.g., input activation element) and an output (e.g., output activation element) of the corresponding layer. For example, weight elements applied to the first layer 10-1 may be referred to as first weight elements, and first activation elements output from the first layer 10-1 may be acquired according to operation (e.g., dot product) between input activation elements input to the first layer 10-1 and the first weight elements.

The activation element may represent a value converted according to operation with a weight after an input (or input activation element) of each layer (or neuron) is delivered to the corresponding layer and may correspond to a value output from each layer. Depending on example embodiment, this activation element may represent a result of applying a predetermined activation function to the converted value.

In an example embodiment, the model 50 may be a model of which training is already completed. Here, quantization in the example embodiment may be quantization performed for the model of which training is already completed, that is, post-training quantization (PTQ). That is, weight elements applied to the model 50 and/or activation elements output from the layers 10 may be quantized according to post-training quantization.

In an example embodiment, before performing such quantization, at least some of the first weights applied to the first layer 10-1 may be regularized. For example, the computer system 100 may identify a first outlier that is at least one outlier from among first activation elements that are output activation elements output from the first layer 10-1 (\textcircled{1}), may analyze relevance between the first weights applied to the first layer 10-1 and the first outlier, may determine the first weight element subject to regularization among the first weight elements, and may regularize the determined first weight element (\textcircled{2}). The computer system 100 may perform quantization for the model 50 after regularization (\textcircled{3}).

The aforementioned regularization of the weight element may be performed for each of the plurality of layers 10 and may be sequentially performed for each layer, starting from the input layer. Alternatively, regularization of the weight element may be sequentially performed for each layer, starting from the input layer until the model 50 is made lightweight by a desired rate (level) (i.e., until the model 50 is pruned to a desired rate (level)).

As such, in an example embodiment, since a weight element closely related to operation of an activation element corresponding to an outlier among activation elements of the model 50 is initially regularized and quantization of the model 50 is performed, quantization errors caused by the outlier may be reduced. That is, through quantization according to an example embodiment, quantization errors increasing due to presence of the outlier in activation elements may be excluded and accordingly, performance of the model 50 after quantization may be improved.

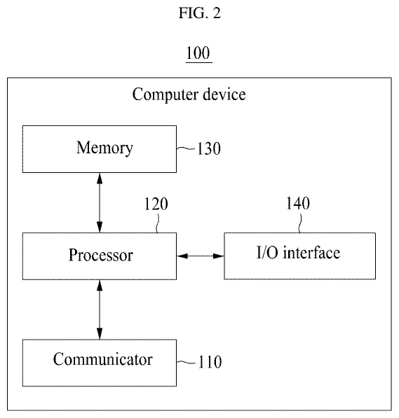

A method of identifying, by the computer system 100, the first outlier from among the first activation elements output from the first layer 10-1, determining the first weight element subject to regularization based on relevance with the first outlier, and quantizing the model 50 after regularizing the first weight element is further described with reference to FIGS. 2 to 8 below.

FIG. 2 is a diagram illustrating a computer system to perform a quantization method of an artificial neural network model according to an example embodiment.

The computer system 100 may be an electronic device with the aforementioned model 50 built or accessible to the model 50. As described above, the computer system 100 may identify the first outlier from among the first activation elements output from the first layer 10-1, may determine the first weight element subject to regularization based on relevance with the first outlier, and may quantize the model 50 after regularizing the first weight element.

The computer system 100 may be a computing device that includes a server configured to perform the quantization method of an example embodiment for the model 50 or resources for the same. Meanwhile, the model 50 quantized according to the quantization method of the example embodiment may be implemented to be relatively lightweight and thus may be implemented on a mobile device or an edge device. The mobile device or the edge device refers to a computing device and may include, for example, a personal computer (PC), a laptop computer, a smartphone, a tablet, an Internet of things (IoT) device, and a wearable computer.

Referring to FIG. 2, the computer system 100 may include a memory 130, processor 120, a communicator 110, and an input/output (I/O) interface 140.

The memory 130 may include a permanent mass storage device, such as random access memory (RAM), read only memory (ROM), and disk drive, as a computer-readable recording medium. Here, the permanent mass storage device, such as ROM, may be included as a separate permanent storage device separate from the memory 130. Also, an operating system (OS) and at least one program code may be stored in the memory 130. Such software components may be loaded from another computer-readable recording medium separate from the memory 130. The separate computer-readable recording medium may include, for example, a computer-readable recording medium, for example, a floppy drive, a disk, a tape, a DVD/CD-ROM drive, and a memory card. In another example embodiment, the software components may be loaded to the memory 130 through the communicator 110, instead of the computer-readable recording medium.

The processor 120 may be configured to process instructions of a computer program by performing basic arithmetic operations, logic operations, and I/O operations. The computer-readable instructions may be provided by the memory 130 or the communicator 110 to the processor 120. For example, the processor 120 may be configured to execute the received instructions according to the program code loaded to the memory 130. The processor 120 may identify the first outlier from among the first activation elements output from the first layer 10-1, may determine the first weight element subject to regularization based on relevance with the first outlier, may regularize the first weight element, and then may quantize the model 50.

The communicator 110 may be a component for the computer system 100 to communicate with another apparatus. That is, the communicator 110 may be a hardware module, such as an antenna, a data bus, a network interface card, a network interface chip, and a networking interface port of the computer system 100 that transmits/receives data and/or information to/from the other apparatus or a software module such as a network device driver or a networking program.

The I/O interface 140 may be a device for interfacing with an input device such as a keyboard and a mouse and an output device such as a display and a speaker.

The processor 120 may manage components of the computer system 100, may execute a program or an application for performing the aforementioned quantization method, and may process operations required for executing the program or the application and processing data. The processor 120 may be at least one processor (CPU and/or GPU) of the computer system 100 or at least one core within the processor.

Also, in example embodiments, the computer system 100 and the processor 120 may include a greater number of components than the number of illustrated components.

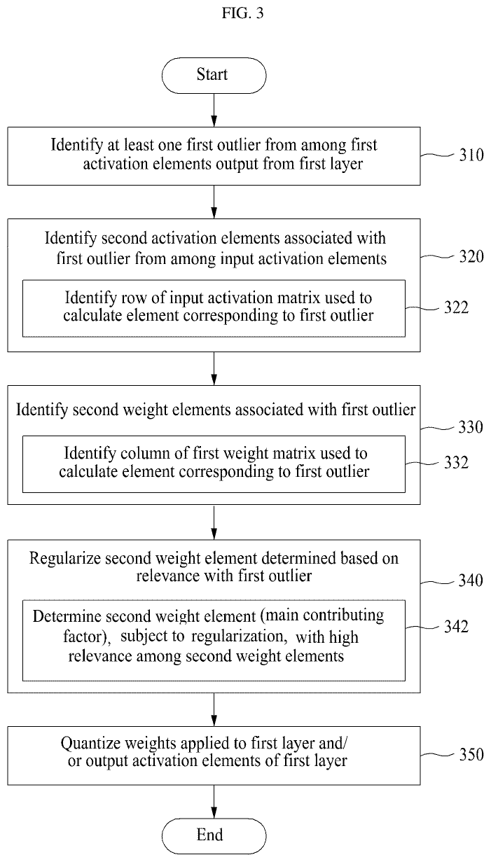

More details for performing the quantization method of the model 50 according to an operation of the computer system 100 are further described with reference to FIGS. 3 to 8 below.

Description related to technical features made above with reference to FIG. 1 may also be applied to FIG. 2 as is and thus, repeated description is omitted.

In the following detailed description, an operation performed by components of the computer system 100 or the processor 120 may be described as an operation performed by the computer system 100, for clarity of description.

FIG. 3 is a flowchart illustrating a quantization method of an artificial neural network model according to an example embodiment.

A method of identifying, by the computer system 100, the first outlier from among the first activation elements output from the first layer 10-1, determining the first weight element subject to regularization based on relevance with the first outlier, and quantizing the model 50 after regularizing the first weight element is described with reference to FIG. 3.

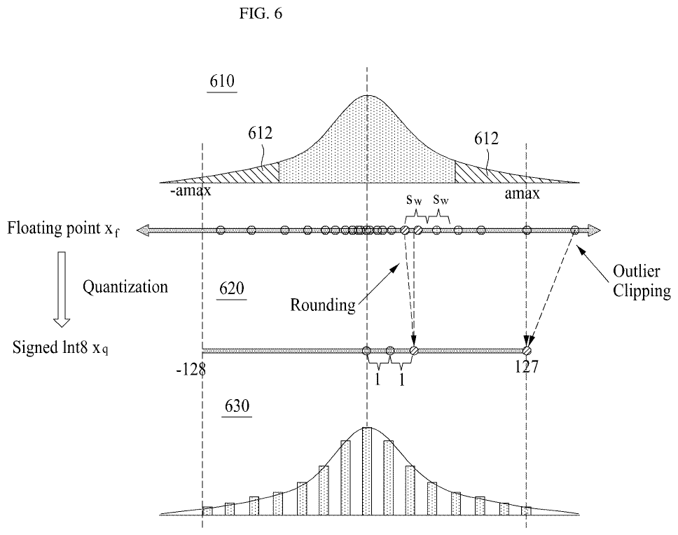

Referring to FIG. 3, in operation 310, the computer system 100 may identify at least one first outlier from among first activation elements output from the first layer 10-1 among the plurality of layers 10 of the artificial neural network model 50. For example, the computer system 100 may determine the first activation element exceeding a predetermined value among the first activation elements as the outlier, or may determine at least one first activation element as the outlier based on deviation, variance, or distribution of the first activation elements. A method of determining the outlier among the first activation elements is further described with reference to FIG. 5 below.

The first activation elements output from the first layer 10-1 may be determined through operation between input activation elements input to the first layer 10-1 and first weight elements applied to the first layer 10-1. The operation may be, for example, an element-wise multiplication.

In operation 320, the computer system 100 may identify second activation elements associated with the first outlier identified in operation 310 from among the input activation elements that are input to the first layer 10-1. The computer system 100 may identify the second activation element(s) that is an activation element used to calculate first outliers from among the input activation elements, based on the first weight elements applied to the first layer 10-1 and the first activation elements corresponding to the identified first outlier among the first activation elements.

In operation 330, the computer system 100 may identify the second weight elements associated with the first outlier from among the first weight elements applied in the first layer 10-1. For example, the computer system 100 may identify the first weight element(s) used to calculate the corresponding first outlier as the second weight element(s), based on the second activation elements identified in operation 320 and the first outlier.

As described with operations 320 and 330, the first outlier may be defined as being calculated by operation between the second activation elements and the second weight elements.

In operation 340, the computer system 100 may regularize the second weight element determined based on relevance with the first outlier, among the second weight elements identified in operation 330. That is, the computer system 100 may determine the second weight element subject to regularization among the second weight elements based on relevance with the first outlier and may regularize the determined second weight element. For example, the computer system 100 may determine the second weight element having the highest relevance with the first outlier (i.e., corresponding to a main contributing factor) or a predetermined number of second weight elements having relatively high relevance as being subject to regularization. As in operation 342, the computer system 100 may determine the second weight element corresponding to the main contributing factor in calculating the first outlier among the second weight elements identified in operation 330, as the second weight element that is subject to regularization. The second weight element corresponding to the main contributing factor may represent the second weight element that contributes the most to calculation of the first outlier.

In operation 350, the computer system 100 may perform quantization for the model 50 in which the weight element(s) are regularized in operation 340. The quantization may be performed for the weight elements and/or activation elements. For example, the computer system 100 may perform quantization for at least one of third weight elements (i.e., first weight elements after the regularization of the the second weight element) applied in the first layer 10-1 after regularization of the weight element or activation elements output from the first layer 10-1. The third weight elements may include the first weight elements, excluding the second weight element, along with the regularized second weight element, and are applied as the weight elements in the first layer 10-1 after regularization. By performing this quantization, the model 50 may be made lightweight. Also, by initially regularizing the second weight element closely associated with the identified first outlier among the first activation elements and then performing quantization, quantization errors that may be caused by the first outlier may be excluded.

In an example embodiment, each of weight elements and activation elements may be an element of a matrix and operation between elements may be represented as operation between matrices.

For example, each of the aforementioned first activation elements may be an element included in a first activation matrix, and each of the input activation elements may be an element included in an input activation matrix. Also, each of the first weight elements may be an element included in a first weight matrix. Here, the first activation matrix may be calculated by operation (e.g., dot product) between the input activation matrix and the first weight matrix.

In operation 322, in identifying the second activation elements, the computer system 100 may identify a row of the input activation matrix used to calculate the element corresponding to the first outlier of the first activation matrix. The computer system 100 may determine element(s) included in the identified row as the first activation elements.

Meanwhile, in operation 332, in identifying the second weight elements, the computer system 100 may identify a column of the first weight matrix used to calculate the element corresponding to the first outlier of the first activation matrix. The computer system 100 may determine element(s) included in the identified column as the second weight elements.

In determining the second weight element corresponding to the main contributing factor in operation 342 described above, the computer system 100 may determine, as the main contributing factor, an element of the column of the first weight matrix corresponding to a largest value (i.e., used to calculate largest value) among element-wise products of the row of the input activation matrix identified in operation 322 and the column of the first weight matrix identified in operation 332. In this example, a size of the calculated element-wise product may represent relevance between the second weight and the first outlier.

Each of the layers 10 included in the model 50 of an example embodiment, for example, a DNN model may be a linear layer or a convolutional layer, and a regularization method of an example embodiment may be applied to a layer that includes a multiplication (e.g., dot product) operation between the activation element and the weight element, such as the above layer. For example, in the case of the linear layer, its output may include a matrix multiplication and a bias addition. In an example embodiment, a bias element may not be considered based on the fact that a part corresponding to the matrix multiplication occupies most of a computational amount and the bias element does not have a large influence.

As described above, the aforementioned relevance between the second weight elements and the first outlier may be defined as being determined by considering second activation elements calculated with the second weight elements among the input activation elements input to the first layer 10-1.

Accordingly, in an example embodiment, the second weight closely associated with the first outlier among the first activation elements may be accurately determined as subject to regularization and accordingly, quantization errors may be reduced after quantization of the model 50.

Regularization of the second weight element (determined as subject to regularization) described above may include pruning the corresponding second weight element. Pruning of the second weight element may include adjusting a value of the second weight element to 0 or adjusting the value to another value. By adjusting the value of the second weight element through pruning, the model 50 may be made lightweight.

Pruning of the second weight element in the example embodiment may be unstructured pruning. Unstructured pruning of the second weight element relates to rule-based pruning and may include adjusting the value of the second weight element (i.e., adjusting the value to 0 or another value) according to a preset standard.

Regularization of operation 340 described above may be performed during quantization calibration on the artificial neural network model 50. Also, the aforementioned operations 310 to 330 may be performed during this quantization calibration.

That is, when performing quantization calibration on the artificial neural network model 50, the computer system 100 may identify the first outlier from among the first activation elements output from the first layer 10-1, may determine the second weight element subject to regularization (or pruning) in consideration of relevance with the first outlier, and may regularize the second weight element, thereby reducing the influence by the outlier and, as a result, reducing quantization errors after quantization of the model 50. Accordingly, quantization of pruning (quantization)-based model 50 may be achieved.

Meanwhile, as described above, quantization of the example embodiment may be PTQ applied to a model of which training is already completed. The PTQ may be performed for the weight element and/or activation element of the model 50. In the case of the weight element, the weight element is stored in a computer system (e.g., computer system 100) in which the model 50 is installed and thus, may be subject to direct quantization. In the case of the activation element, the activation element output from (or input to) each layer of the model 50 may be subject to quantization. To perform quantization for the activation element, a quantization element parameter (e.g., scale, zero_point, etc.) may need to be calculated first and the aforementioned quantization calibration may be performed to find distribution of activation elements. That is, to find distribution of actual activation elements of the model 50, calibration on the model 50 may be performed with sample inputs, calibration data. This calibration may allow the model 50 to perform inference using at least a portion of training data (i.e., sample inputs) used to train the model 50 as input. During inference of the model 50, the aforementioned quantization parameter may be calculated based on output data from the layer. In this aspect, the first activation elements output from the first layer 10-1 of the model 50 may be acquired by averaging the activation elements output from the first layer 10-1 for each of the sample inputs used for the quantization calibration. The computer system 100 may identify the first outlier from among the averaged first activation elements.

Description related to technical features made above with reference to FIGS. 1 and 2 may also be applied to FIG. 3 as is and thus, repeated description is omitted.

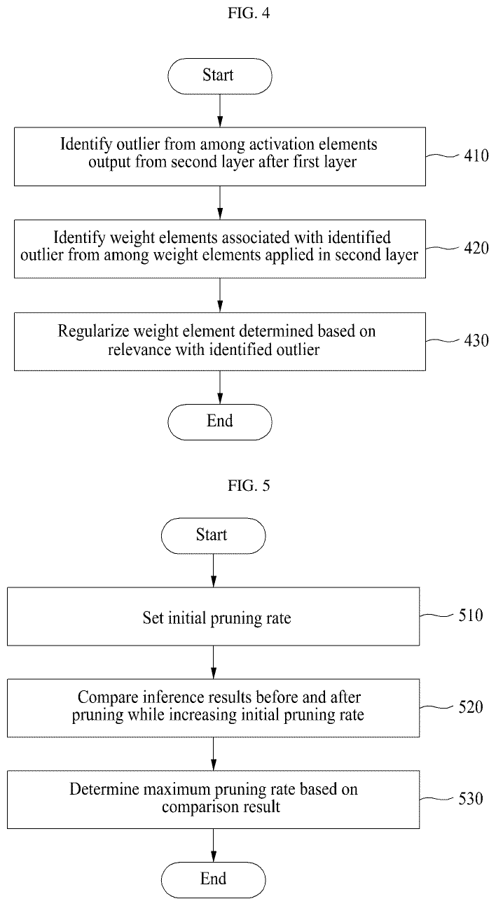

FIG. 4 is a flowchart illustrating a method of regularizing a weight applied to each of a plurality of layers of an artificial neural network model and quantizing the artificial neural network model according to an example.

Hereinafter, a method of performing the aforementioned weight element regularization for two or more layers among the plurality of layers 10 that constitute the model 50 and quantizing the model 50 is further described.

As will be described below with reference to operations 410 to 430, regularization of the weight element may be performed in a similar manner even for the second layer corresponding to a layer that follows the first layer 10-1.

In detail, in operation 410, the computer system 100 may identify at least one outlier from among activation elements output from a second layer that follows the first layer 10-1 among the layers 10. An input activation element of the second layer may be activation elements output from the first layer 10-1. Here, the activation elements output from the first layer 10-1 may be output from the first layer 10-1 before regularization of the second weight element described above, after regularization of the second weight element, or regularization and quantization of the second weight element. The method of identifying the first outlier from among the first activation elements described above may be similarly applied to a method of identifying an outlier from among activation elements output from the second layer and thus, repeated description is omitted.

In operation 420, the computer system 100 may identify weight elements associated with the outlier identified in operation 410 from among weight elements applied in the second layer. Meanwhile, as in operation 320 described above, the computer system 100 may further identify activation elements associated with the identified outlier from among the input activation elements of the second layer. The method of identifying the second weight elements described above with reference to operation 430 of identifying the weight elements associated with the outlier in operation 420 may be similarly applied and thus, repeated description is omitted.

In operation 430, the computer system 100 may regularize a weight element determined based on relevance with the outlier identified in operation 410 among the weight elements identified in operation 420. The regularization method of the second weight element in operation 340 may be similarly applied to regularization of the weight element in operation 430 and thus, repeated description is omitted. For example, the computer system 100 may determine the weight element having the highest relevance with the outlier identified in operation 410 from among the weight elements identified in operation 420. The computer system 100 may regularize the determined weight element having the highest relevance with the outlier.

As described with reference to operations 310 to 340, operation 430 or operations 410 to 430 may be performed during quantization calibration of the model 50.

For example, the aforementioned first layer 10-1 may be an input layer that is the first layer of the artificial neural network model 50 and the second layer that is a layer following the input layer, that is, the second layer.

As described above, regularization of the weight element in the example embodiment may be performed on each of two or more layers of the plurality of layers 10 and may be sequentially performed for each layer, starting from the input layer. Alternatively, regularization of the weight element may be sequentially performed for each layer, starting from the input layer, until the model 50 is made lightweight by a desired rate (level) (i.e., until the model 50 is pruned to the desired rate (level)). Further description related thereto is made below with reference to FIG. 5.

Description related to technical features made above with reference to FIGS. 1 to 3 may also be applied to FIG. 4 as is and thus, repeated description is omitted.

FIG. 5 is a flowchart illustrating a method of pruning an artificial neural network model according to a set pruning rate in regularizing the weight of the artificial neural network model according to an example.

Hereinafter, a method of making the model 50 lightweight by a preset rate or level by determining an outlier (e.g., the aforementioned first outlier) among activation elements (e.g., the aforementioned first activation elements) and by regularizing a weight element (e.g., the determined second weight element described above) is further described.

The aforementioned operations 310 to 340 including operation 310 of identifying the first outlier, operation 330 of identifying the second weight elements, and operation 340 of regularizing the same may be sequentially performed for each layer, starting from the input layer that is the first layer 10-1 of the artificial neural network model 50 among the layers 10 of the model 50, and may be performed until the artificial neural network model 50 satisfies a preset maximum pruning rate. That is, regularization of the second weight in the example embodiment may be sequentially performed, starting from the input layer that has a greater influence in inference, which may further improve performance (e.g., inference accuracy) of the model 50 after quantization for the model 50.

The maximum pruning rate (r) refers to a hyperparameter and may be a value predetermined by an administrator or a user of the model 50. The maximum pruning rate (r) may be an empirically recognized value or a value preset according to any other standards. r may be a value between 0 and 1 (evaluation-free method).

Alternatively, the maximum pruning rate may be determined through operations 510 to 530 described below (evaluation-based method).

In operation 510, the computer system 100 may set an initial pruning rate. For example, the computer system 100 may set the initial pruning rate to 0.

In operation 520, the computer system 100 may compare an inference result by a model in which the artificial neural network model 50 is pruned (e.g., regularization of weight element is applied) while increasing the set initial pruning rate and an inference result by an initial model that is the unpruned artificial neural network model 50. In this manner, the computer system 100 may compare the inference results before and after pruning of the model 50. The increase in the initial pruning rate may be performed at a constant size or rate.

In operation 530, the computer system 100 may determine the maximum pruning rate as a value that increases the initial pruning rate based on a change in the comparison result.

Operations 510 to 530 may also be performed during quantization calibration. For example, the computer system 100 may allow the model 50 to perform inference while increasing the initial pruning rate using calibration data described above, and may compare the inference results (i.e., output) of the model 50 according to the gradual increase in the initial pruning rate. For example, the computer system 100 may compare KL-divergence between the output of the model 50 corresponding to the original and the output of the model 50 acquired by increasing the initial pruning rate. The computer system 100 may further increase the initial pruning rate by a certain level and then repeat the comparison and may determine, as the maximum pruning rate, a value of the pruning rate increased when the KL-divergence changes sharply (change by certain level or more), for example, decreases sharply. A level of increasing the initial pruning rate may be preset as a hyperparameter, for example, 1%. As a result, the computer system 100 may automatically set the maximum pruning rate that the model 50 targets.

Meanwhile, the method of identifying the first outlier from among the first activation elements is further described. For example, the computer system 100 may determine the first activation element exceeding a predetermined value among the first activation elements as the outlier, or may determine at least one first activation element as the outlier based on deviation, variance, or distribution of the first activation elements.

When the first activation elements follow normal distribution, the computer system 100 may identify the first outlier using the mean and standard deviation.

When the first activation elements follow non-normal distribution, the computer system 100 may identify the first outlier using median absolute deviation (MAD). The computer system 100 may select a predetermined number of first outliers from among the first activation elements using MAD.

The computer system 100 may identify the first outlier from among the first activation elements based on the MAD and the predetermined rate or number. As described above, the first activation elements may correspond to a statistical value (e.g., average of absolute values) of an activation matrix corresponding to an output from the first layer 10-1 acquired during a calibration process. Here, the predetermined rate or number may be a value that is determined based on, for example, the total number of weight elements of the artificial neural network model 50. The predetermined rate or number may be determined according to the aforementioned maximum pruning rate (r). The maximum pruning rate may be defined as ‘number of weights to be pruned (regularized)/total number of weights’ and the first outlier may be selected from among the first activation elements in consideration of the rate or the number of weights to be pruned.

Hereinafter, the method of identifying the first outlier from among the first activation elements is further described. The computer system 100 may identify the first outlier from among the first activation elements based on MAD and may identify the outlier sequentially for each layer, starting from the input layer. Here, the computer system 100 may identify the outlier until the aforementioned maximum pruning rate (r) is reached. In detail, initially i) median may be calculated for an activation matrix (X) of the first activation elements (“median (X)”). Then, an absolute value of deviation of each element (x) of the activation matrix (X) may be calculated based on the median (X) (“abs(x−median(X))”). MAD may be calculated as a value acquired by multiplying MAD by constant (consist.constant) (“mad=median(abs(x−median(X)))Xconsist.constant”). Here, when the first activation elements follow the normal distribution, constant (consist.constant) may be set to 1.4826.

If a value acquired by dividing the absolute value of deviation of each element (x) by the MAD value is greater than MAD, the computer system 100 may determine the corresponding element as the outlier. That is, an activation element corresponding to a case in which “abs(x−median(X))/MAD” is greater than MAD may be determined (identified) as the outlier. In an example embodiment, the number of outliers identified within the model 50 may need to be less than or equal to r % (maximum pruning rate described above) compared to the total weight elements of the model 50 and identifying of the outlier may performed until r % is reached. An outlier after exceeding r % may be skipped.

As a result, according to the determined maximum pruning rate, an appropriate amount of first outliers may be identified within the range that allows performance of the model 50 after pruning to be maintained.

Description related to technical features made above with reference to FIGS. 1 to 4 may also be applied to FIG. 5 as is and thus, repeated description is omitted.

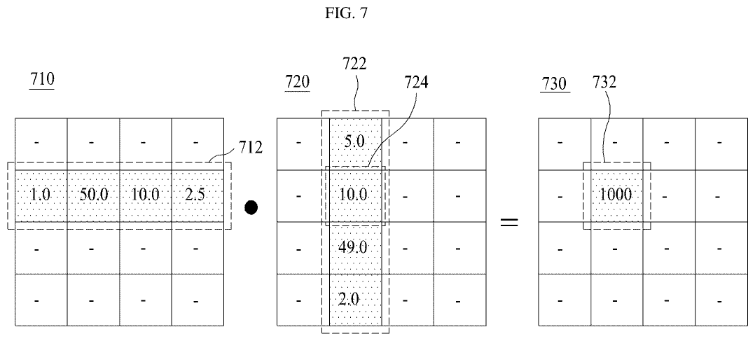

FIG. 6 illustrates a method of identifying an outlier from among activation elements output from a layer of an artificial neural network model and performing quantization of the artificial neural network model according to an example.

FIG. 6 illustrates a distribution 610 of first activation elements described above and a portion 612 corresponding to an outlier among the first activation elements. The outlier may represent an activation element outside a specific range in the distribution 610. Also, as an example of quantization, a method of performing a rounding operation is illustrated (620) and a distribution 630 of activation elements after quantization is performed is also illustrated. Quantization may be a method of expressing the activation element as 2n−1. Here, n is a natural number corresponding to the number of bits.

Through identification of an outlier and regularization of a weight having high relevance therewith as in the example embodiment, outliers that significantly contribute to occurrence of quantization errors may be excluded from the distribution 630. Therefore, it is possible to prevent performance of the model 50 from being degraded due to quantization errors caused by the outlier.

Description related to technical features made above with reference to FIGS. 1 to 5 may also be applied to FIG. 6 as is and thus, repeated description is omitted.

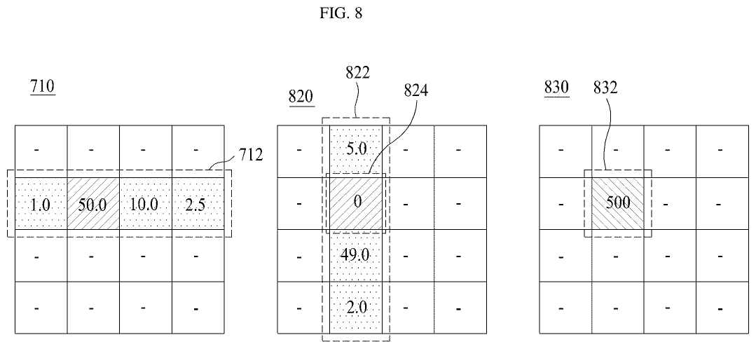

FIGS. 7 and 8 illustrate a method of identifying an outlier from among activation elements output from a first layer of an artificial neural network model, and identifying and regularizing a weight corresponding to a main contributing factor from among weights used to calculate the outlier according to an example.

The regularization method of the example embodiment is further described using inter-matrix operation with reference to FIGS. 7 and 8.

FIG. 7 illustrates an input activation matrix 710 indicating input activation elements of the first layer 10-1 described above, a first weight matrix 720 indicating first weight elements applied to the first layer 10-1, and a first activation matrix 730 indicating first activation elements output from the first layer 10-1. Description related to some elements of a matrix in FIGS. 7 and 8 is omitted.

As shown in FIG. 7, a first outlier 732 may be identified from the first activation matrix 730. The computer system 100 may identify a row 712 indicating activation elements of the input activation matrix 710 associated with the first outlier 732 and a column 722 indicating second weight elements associated with the first outlier of the first weight matrix 720. The first outlier 732 may be calculated according to matrix operation of the row 712 and the column 722. In calculating the first outlier 732, the computer system 100 may determine a weight corresponding to a main contributing factor among weight elements within the column 722. Accordingly, a second weight element 724 may be determined as subject to regularization.

FIG. 8 illustrates a weight matrix 820 after regularization is performed and an activation matrix 830 output from the first layer 10-1 according to operation with the weight matrix 820. As illustrates as an element 824 of the weight matrix 820, the second weight element 724 may be pruned to 0. Therefore, a value of an element 832 of the activation matrix 830 corresponding to the first outlier 732 may be significantly reduced, which may result in significantly reducing influence of the element 832 on quantization errors after quantization of the model 50.

As described above, in an example embodiment, the first weight elements applied to the first layer 10-1 may be appropriately pruned based on the outlier identified from among the activation elements output from the first layer 10-1, thereby making the model 50 lightweight and reducing quantization errors.

Describing FIGS. 7 and 8 in a more general aspect, the i^{th} row 712 of the input activation matrix 710 and the j^{th} column 722 of the first weight matrix 720 to which the first outlier 732 identified from the first activation matrix 730 corresponds may be identified. Here, as element-wise multiplication between elements of the row 712 and the column 722 is performed, a vector corresponding to a length of dimension (d) of the row 712 may be acquired. The computer system 100 may rank each element of the corresponding vector in descending order and may determine an element of the column 722 corresponding to a largest element (i.e., main contributing factor that is a weight element contributing to a largest value in calculating the outlier) as subject to regularization and may set the value to 0.

As described above, through regularization of the weight element in an example embodiment, activation range of activation elements of the first layer 10-1 may be reduced and accordingly, quantization errors may be reduced when performing PTQ for the model 50.

Description related to technical features made above with reference to FIGS. 1 to 6 may also be applied to FIGS. 7 and 8 as is and thus, repeated description is omitted.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, or computer storage medium or device, to provide instructions or data to or to be interpreted by the processing device. The software also may be distributed over network coupled computer systems so that the software is stored and executed in a distributed fashion. The software and data may be stored by one or more computer readable storage mediums.

The methods according to the example embodiments may be implemented in the form of program instructions executable through various computer methods and recorded in non-transitory computer-readable media. Here, the media may continuously store computer-executable programs or may temporarily store the same for execution or download. Also, media may be various types of recording devices or storage devices in the form in which one or a plurality of hardware components are combined. Without being limited to media directly connected to a computer system, the media may be distributed over the network. Examples of the media include magnetic media such as hard disks, floppy disks, and magnetic tapes; optical media such as CD ROM and DVD; magneto-optical media such as floptical disks; and hardware devices that are specially to store instructions, such as read-only memory (ROM), random access memory (RAM), flash memory, and the like. Also, examples of other media may include recording media and storage media managed by an app store that distributes applications or a site, a server, and the like that supplies and distributes other various types of software.

Although the example embodiments are described with reference to some specific example embodiments and accompanying drawings, it will be apparent to one of ordinary skill in the art that various alterations and modifications in form and details may be made in these example embodiments from the description. For example, suitable results may be achieved if the described techniques are performed in different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. A quantization method of an artificial neural network model including a plurality of layers, performed by a computer system, the quantization method comprising:
identifying at least one first outlier from among first activation elements output from a first layer among the layers;
identifying second weight elements associated with the first outlier from among first weight elements applied in the first layer;
regularizing a second weight element determined based on relevance with the first outlier, among the identified second weight elements; and
performing quantization for at least one of third weight elements applied in the first layer after the regularization or activation elements output from the first layer.

2. The quantization method of claim 1, further comprising:
identifying second activation elements associated with the first outlier from among input activation elements that are input to the first layer,
wherein the first outlier is calculated by operation between the second activation elements and the second weight elements, and
the regularizing of the second weight element comprises determining a second weight element corresponding to a main contributing factor in calculating the first outlier among the second weight elements as the second weight element subject to regularization.

3. The quantization method of claim 2, wherein each of the first activation elements is an element included in a first activation matrix,
each of the input activation elements is an element included in an input activation matrix, and
each of the first weight elements is an element included in a first weight matrix.

4. The quantization method of claim 3, wherein the identifying of the second weight elements comprises identifying a column of the first weight matrix used to calculate an element corresponding to the first outlier of the first activation matrix,
the identifying of the second activation elements comprises identifying a row of the input activation matrix used to calculate the element corresponding to the first outlier of the first activation matrix, and
the second weight element corresponding to the main contributing factor is an element of the column of the first weight matrix corresponding to a largest value among element-wise products of the row of the input activation matrix and the column of the first weight matrix.

5. The quantization method of claim 1, wherein the relevance with the first outlier is determined in consideration of second activation elements calculated with the second weight elements among input activation elements that are input to the first layer.

6. The quantization method of claim 1, wherein the regularizing of the determined second weight element comprises pruning the determined second weight element.

7. The quantization method of claim 1, wherein the regularizing is performed during quantization calibration on the artificial neural network model.

8. The quantization method of claim 7, wherein the first activation elements are acquired by averaging the activation elements output from the first layer for each of sample inputs used for the quantization calibration.

9. The quantization method of claim 1, further comprising:
identifying at least one outlier from among activation elements output from a second layer that follows the first layer among the layers;
identifying weight elements associated with the identified outlier from among weight elements applied in the second layer;
determining a weight element having the highest relevance with the identified outlier among the identified weight elements; and
regularizing the weight element having the highest relevance with the outlier.

10. The quantization method of claim 1, wherein the first layer is an input layer that is the first layer of the artificial neural network model.

11. The quantization method of claim 1, wherein operations comprising the identifying of the first outlier, the identifying of the second weight elements, and the regularizing are sequentially performed for each layer, starting from an input layer that is the first layer of the artificial neural network model among the layers, and are performed until the artificial neural network model satisfies a preset maximum pruning rate.

12. The quantization method of claim 11, wherein the maximum pruning rate is determined by:
setting an initial pruning rate;
comparing an inference result by a model in which the artificial neural network model is pruned while increasing the initial pruning rate and an inference result by an initial model that is the artificial neural network model; and
determining the maximum pruning rate as a value that increases the initial pruning rate, based on a change in the comparison result.

13. The quantization method of claim 1, wherein the identifying of the first outlier comprises identifying the first outlier from among the first activation elements based on median absolute deviation (MAD) and a predetermined rate or number of the first activation elements.

14. The quantization method of claim 13, wherein the predetermined rate or number is determined based on the total number of weight elements of the artificial neural network model.

15. A non-transitory computer-readable recording medium to execute the method of claim 1 on the computer system.

16. A computer system to perform quantization of an artificial neural network model including a plurality of layers, the computer system comprising:
at least one processor configured to execute computer-readable instructions in the computer system,
wherein the at least one processor is configured to identify at least one first outlier from among first activation elements output from a first layer among the layers, to identify second weight elements associated with the first outlier from among first weight elements applied in the first layer, to regularize a second weight element determined based on relevance with the first outlier, among the identified second weight elements, and to perform quantization for at least one of third weight elements applied in the first layer after the regularization or activation elements output from the first layer.
